(19) United States
(12) Patent Application Publication
(10) Pub. No.: US 2004/0058055 A1
(43) Pub. Date: Mar. 25, 2004

(54) Process for manufacturing low-fat fiber-enriched snacks and snacks thus obtained

(76) Inventor: Marie Delebarre, La Couture (FR)

Correspondence Address: STURM & FIX LLP, 206 SIXTH AVENUE, SUITE 1213, DES MOINES, IA, 50309-4076, US

(21) Appl. No.: 10/627,378

(22) Filed: Jul. 25, 2003

(30) Foreign Application Priority Data
Aug. 5, 2002 (FR) FR 02 09962

(51) Int. Cl. A23G 3/00

(52) U.S. Cl. 426/661; 426/658

(57) ABSTRACT

The subject of the invention is a process for manufacturing low-fat fibre-enriched snacks, characterized in that it comprises the step consisting in incorporating from 1 to 30%, preferably from 2 to 20% and still more preferably from 2.5 to 15% by weight relative to the finished product of branched maltodextrins having between 15 and 35% 1→6 glucoside bonds, a reducing sugar content of less than 10%, a molecular weight Mw of between 4000 and 6000 g/mol and a number-average molecular weight Mn of between 2000 and 4000 g/mol.

The subject of the invention is also a low-fat fibre-enriched snack, characterized in that it comprises from 1 to 30%, preferably from 2 to 20% and still more preferably from 2.5 to 15% by weight relative to the finished product of the said branched maltodextrins.

The subject of the present invention is a process for manufacturing low-fat fibre-enriched snacks using a particular saccharide. Its subject is also the snacks obtained according to this process, containing such a particular saccharide.

The expression snacks is understood to mean, for the purposes of the present invention, products such as crisps obtained by laminating and cutting a paste and the products obtained by extruding a paste so as to obtain very diverse shapes: cylindrical, as thin sections, as sticks and the like, which are cooked by frying.

The expression “low-fat” is understood to mean, for the purposes of the present invention, products which exhibit, during frying, a lower oil uptake than standard products. Indeed, fried snacks have the disadvantage, during cooking, of absorbing a non-negligible quantity of frying oil. The products obtained are then rich in fat, which runs counter to the new wishes of consumers for low-fat products. Several solutions have been proposed for limiting the uptake of oil by these products, such as in particular coating before cooking the snacks using various film-forming compounds such as starch. Another solution, described in patent EP 0 418 955 A2, consists in using a paste comprising conventional maltodextrins or dehydrated glucose syrups obtained from the hydrolysis of starch and having a DE of between 5 and 30, preferably of between 10 and 20, that is a reducing sugar content greater than 5% and preferably greater than 10%. The snacks thus prepared exhibit a limited oil uptake compared with the prior art products because the maltodextrins used make it possible to prepare a paste having a lower water content. It is indeed known that the higher the water content of the paste, the higher the oil uptake during frying.

In addition to this wish to manufacture products which are low in high-calorie substances, manufacturers are increasingly preoccupied with nutrition and the potential benefits of foods. Indeed, the frequency of cancers and coronary diseases, the distrust of consumers following recent crises in the agri-foodstuffs industry, and the popularization of recent nutritional knowledge accentuate this expectation of healthy products which make it possible to live better and longer. Dietary fibre has thus come to the forefront of functional ingredients. Indeed, it plays a role of protecting against cancer, cardiovascular diseases, diabetes or obesity. It therefore seems advantageous to enrich foods with fibre. The latter should however exhibit satisfactory stability to the various treatments to which the food is subjected, in particular the steps of cooking at high temperature, so that the supply of fibre is not impaired downstream of the manufacturing processes.

Having acknowledged this state of the art, the applicant company set itself the objective of developing low-fat fibre-enriched snacks using a technological ingredient which satisfies all the abovementioned requirements, that is to say which limits the uptake of oil by the products during frying while constituting a supply of fibre capable of withstanding the high temperatures applied during the said frying. The standard maltodextrins in question in the abovementioned patent EP 0 418 955 A2 are perfectly digestible by the human enzymatic system and do not therefore constitute a supply of fibre for the purpose of the present invention. Indeed, starches and maltodextrins contain solely 1→4 glucoside (95%) and 1→6 glucoside (5%) bonds which are hydrolyzable by the human digestive system.

It is after numerous trials and studies that the applicant company has had the merit of finding that the objective defined above could be achieved by using a branched maltodextrin having very particular analytical parameters.

The subject of the present invention is therefore a process for manufacturing fibre-enriched snacks, characterized in that it comprises the step consisting in incorporating into the paste used for the manufacture of said snacks from 1 to 30%, preferably from 2 to 20% and still more preferably from 2.5 to 15% by weight relative to the finished product, of branched maltodextrins having between 15 and 35% 1-+6 glucoside bonds, a reducing sugar content of less than 10%, a molecular weight Mw of between 4000 and 6000 g/mol and a number-average molecular weight Mn of between 2000 and 4000 g/mol.

The expression branched maltodextrins is understood to mean, for the purposes of the present invention, maltodextrins as described in patent application EP 1,006,128 of which the applicant is the proprietor. These branched maltodextrins exhibit an indigestibility character which has the consequence of reducing their calorific value, by preventing their assimilation in the small intestine. They therefore represent a source of indigestible fibre which is beneficial for metabolism and for intestinal balance. As a guide, their insoluble fibre level determined by the AOAC method (Prosky method, 985-29 (1986)) is generally greater than 50% on a dry matter basis. Their low content of molecules having a low degree of polymerization (“DP”) also contributes to their low calorific value. Their high content of 1->6 glucoside bonds has the consequence of reducing their cariogenic power by reducing their assimilation by the microorganisms in the buccal cavity. This high level of 1-+6 bonds also confers quite particular prebiotic properties on them: it has indeed appeared that the bacteria of the caecum and of the colon of humans and animals, such as butyrogenic, lactic or propionic bacteria, metabolize highly branched compounds. Moreover, these branched maltodextrins promote the development of bifidogenic bacteria at the expense of undesirable bacteria. This results in properties which are entirely beneficial for the health of the consumer.

Products having similar functionalities, such as in particular the soluble fibre marketed by MATSUTANI under the name FIBERSOL® and described in patent EP 0 358 461, which also have beneficial effects on health in terms of bifidogenic properties and supply of fibre, have been provided in fibre-enriched foods. These products have nevertheless the disadvantage of being unstable at high temperatures, as will in fact be exemplified. This instability results in substantial and gradual hydrolysis during cooking, which generates an undesirable release of glucose and fructose. This instability is dissuasive for use in snacks which are subjected to high frying temperatures. The same applies to products derived from inulin, such as in particular the fructooligosaccharides widely used as source of fibre, which are also subject to hydrolysis at high temperature.

The applicant then found that by using the said particular branched maltodextrins in a process for manufacturing low-fat snacks, it was possible advantageously to obtain fibre-enriched low-fat snacks by a process which is simple to carry out. Indeed, the incorporation of the said branched maltodextrins considerably limits the uptake of fat by the snacks during frying, even for high water contents in the paste. Moreover, the said branched maltodextrins are relatively stable to cooking as will in fact be exemplified.

According to a preferred variant, the said branched maltodextrins have a reducing sugar content of between 2 and 5% and an Mn of between 2000 and 3000 g/mol.

The reducing sugar contents in question in the present invention are expressed as glucose, in weight relative to the dry weight of the product, and are measured by the BERTRAND method.

According to another advantageous variant, all or some of the branched maltodextrins are hydrogenated.

The subject of the invention is also low-fat fibre-enriched snacks, characterized in that they comprise from 1 to 30%, preferably from 2 to 20% and still more preferably from 2.5 to 15% as dry weight relative to the finished product, of branched maltodextrins having between 15 and 35% of 1→6 glucoside bonds, a reducing sugar content of less than 10%, a molecular weight Mw of between 4000 and 6000 g/mol and a number-average molecular weight Mn of between 2000 and 4000 g/mol.

Advantageously, said branched maltodextrins have a reducing sugar content of between 2 and 5% and an Mn of between 2000 and 3000 g/mol.

According to another advantageous variant, all or some of the said branched maltodextrins are hydrogenated.

To prepare the snacks according to the present invention, the procedure is carried out as follows, or in an equivalent manner.

A paste is prepared which comprises a source of starch, branched maltodextrins according to the invention, optionally an emulsifier and water.

The source of starch is provided by a flour. It is preferable to use a potato flour, it being possible for the latter to be provided for example in the form of potato flakes or granules. Other sources of starch may however be used, alone or in the form of various mixtures such as in particular wheat, rice, soya bean, oat, pea or tapioca flours.

The source of starch may also be supplemented by a supply of starches of any origin, native or modified starches. Generally, the source of starch represents 50 to 90% by weight of the paste.

The branched maltodextrins represent 1 to 30%, preferably 2 to 20% and still more preferably 2.5 to 15% as dry weight of the paste.

It is possible to add up to about 5% of emulsifiers, and various food ingredients suitable for the preparation of snacks, such as for example salt, sugar, flavourings and colourings.

As a guide, very good results were obtained by formulating snacks comprising, on a dry matter basis:

6 to 14% of branched maltodextrins having a reducing sugar content of between 2 and 5%, a molecular weight Mw of between 4000 and 6000 g/mol and an average molecular weight Mn of between 2000 and 3000 g/mol;

at least 80% of a source of starch;

at least 0.5% of emulsifiers.

The water content of the paste is adjusted in order to obtain a hydration of the paste of between 20 and 45%, it being necessary for this hydration to allow sufficient machinability in order to laminate and cut the paste before cooking. The paste may be obtained by various techniques known to persons skilled in the art, such as in particular by blending the ingredients in a mixer, or in an extrusion installation.

It is then spread by laminating as a thin layer which is then cut according to the desired shapes of articles. The paste may also be formed using the extrusion installation.

The formed articles are then cooked by frying, according to conventional processes. By way of example, the cooking is performed in an oil bath at 195° C. for 15 seconds. Snacks are then obtained which have a light and crunchy consistency.

It is also possible to envisage incorporating the branched maltodextrins according to the invention into a mixture with other types of maltodextrin, such as for example standard maltodextrins. As a guide, good results have been obtained by mixing about 1 to 2.5% of standard maltodextrins having a reducing sugar content greater than 5% with at least 1% of branched maltodextrins according to the invention, these percentages being expressed as dry weight relative to the finished product. According to a preferred variant, the said branched maltodextrins have a reducing sugar content of less than 5%, and are incorporated in an amount of 1 to 30% by dry weight.

Some subfamilies of branched maltodextrins described in the patent application EP 1,006,128 may also be mixed with the branched maltodextrins in accordance with the invention, without however exceeding 2.5% by weight relative to the finished product. They are in particular low molecular weight branched maltodextrins having a reducing sugar content of between 5 and 20% and a molecular weight Mn of less than 2000 g/mol.

The invention will be understood more clearly on reading the examples which follow, which are intended to be illustrative and not limiting.

### EXAMPLE 1

### Preparation of Stackabl Laminated Snacks According to the Invention and Comparison to Prior Art Products

There are prepared according to the following formula low-fat stackable laminated snacks according to the prior art:

| | |
|---|---|
| potato flakes | 43.3% |
| potato granules | 19.7% |
| maize starch | 16.7% |
| wheat starch | 9.0% |
| Dimodan PVP (emulsifier) | 3.0% |
| maltodextrin* | 6.7% |
| dextrose | 1.6% |

*GLUCIDEX ®6 or GLUCIDEX ®19 marketed by the applicant.

Low-fat fibre-enriched stackable laminated snacks are prepared according to the same formula, the 6.7% of standard maltodextrins being replaced by 6.7% of branched maltodextrins according to the invention.

The branched maltodextrins according to the invention have the following composition:

| | |
|---|---|
| reducing sugars | 2.3 |
| Mn (g/mol) | 2480 |
| Mw (g/mol) | 5160 |
| 1, 2 bond (%) | 10 |
| 1, 3 bond (%) | 12 |
| 1, 4 bond (%) | 49 |
| 1, 6 bond (%) | 29 |

The standard maltodextrins GLUCIDEX®6 and GLUCIDEX®19 have, for their part, a reducing sugar level of 6 and 12%, respectively, and a 1→6 glucoside bond level of less than 15% and a molecular weight Mw greater than 6000 g/mol.

The various ingredients are mixed and water is incorporated in order to obtain a 40% hydration of the paste. The mixture obtained is put through an extruder in the cold state in order to obtain a paste which is then laminated and cut into crisps.

The crisps are then fried in oil at 195° C. for 15 seconds.

The products obtained have a water content of about 3 to 4%. They are analyzed in order to determine the fat content and the INSTRON hardness (N).

The results are given in the table below:

| | | | FAT CONTENT | |
|---|---|---|---|---|
| | | | on a dry | INSTRON |
| | WATER | | matter | HARDNESS |
| | CONTENT | | basis | (N) |
| | before | after | after | after |
| | cooking | cooking | cooking | cooking |
| GLUCIDEX ®6 | 42.6% | 3.7% | 37.7% | 4.6 ± 1 |
| GLUCIDEX ®19 | 45.3% | 3.7% | 39.7% | 3.5 ± 0.8 |
| branched | 41.7% | 3.5% | 32.8% | 3.4 ± 0.8 |
| maltodextrins | | | | |
| according to | | | | |
| the invention | | | | |

The replacement of the standard maltodextrins with the branched maltodextrins according to the invention allows a reduction in the uptake of oil during frying. The snacks obtained according to the invention do not show a perceptible difference in terms of texture compared with the prior art; they are in addition advantageously enriched with fibres.

### EXAMPL 2

### Influence of the Content of Branch d Maltodextrins and Comparison with the Prior Art

Low-fat fibre-enriched snacks are prepared according to the same process as the preceding example, with rates of incorporation of branched maltodextrins varying from 0 to 13.3%.

Comparative formulas are prepared by replacing the branched maltodextrins according to the invention th soluble fibre of the prior art.

This soluble fibre has a reducing sugar content greater than 10%, a molecular weight Mw of less than 4000 g/mol and a number-average molecular weight of less than 2000 g/mol. This product has, moreover, an insoluble fibre level of less than 50% (determined by the AOAC 985-29 method).

The following formulas are used (quantities in % by dry weight):

| | A | B | C | D |
|---|---|---|---|---|
| potato flakes | 46.7 | 43.3 | 41.7 | 40.2 |
| potato granules | 21.2 | 19.7 | 19 | 10.9 |
| maize starch | 17.8 | 16.7 | 16 | 9.2 |
| wheat starch | 9.7 | 9 | 8.7 | 5 |
| Dimodan PVP | 3 | 3 | 3 | 1.8 |
| branched maltodextrins | 0 | 6.7 | 10 | 13.3 |
| according to the invention | | | | |
| or soluble fibre of the | | | | |
| prior art | | | | |
| dextrose | 1.6 | 1.6 | 1.6 | 1.6 |

The snacks are prepared under the same conditions as Example 1. After frying, the fat contents, the INSTRON hardness, the water content and the residual content of branched maltodextrins according to the invention or of soluble fibres of the prior art, reflecting the possible hydrolysis during frying, are measured.

The results are presented in the table below:

| | Content of | | | | | | |
|---|---|---|---|---|---|---|---|
| | branched malto- | | | | | Content of | |
| | dextrins or of sol- | | | | | fat on a | INSTRON |
| | uble fibres on a | | | | | dry matter | hardness |
| | dry matter basis | | | Water content | | basis | (N) |
| | before | after | Loss during | before | after | before | after |
| | cooking | cooking | drying | cooking | cooking | cooking | cooking |
| Formula A | 0% | 0% | — | 43% | 5.1% | 36.9% | 4.5 ± 0.5 |
| soluble fibre | | | | | | | |
| Formula A | 0% | 0% | — | 41.7% | 4.2% | 35.2% | 3.0 ± 0.5 |
| branched | | | | | | | |
| maltodextrins | | | | | | | |
| Formula B | 6.97% | 4.77% | −31.6% | 42.6% | 3.5% | 35.9% | 3.6 ± 0.6 |
| soluble fibre | | | | | | | |
| Formula B | 6.5% | 5.2% | −20% | 41.7% | 3.5% | 32.8% | 3.4 ± 0.8 |
| branched | | | | | | | |
| maltodextrins | | | | | | | |
| Formula C | 10.64% | 7.45% | −30% | 43.6% | 3.3% | 35.0% | 3.6± 0.6 |
| soluble fibre | | | | | | | |
| Formula C | 10.6% | 8.3% | −21.7% | 42.5% | 2.9% | 30.0% | 3.5 ± 0.5 |
| branched | | | | | | | |
| maltodextrins | | | | | | | |
| Formula D | 14.04% | 10.86% | −22.6% | 41.6% | 3.3% | 35.0% | 3.9 ± 0.7 |
| soluble fibre | | | | | | | |
| Formula D | 13.7% | 11.9% | −13.1% | 42.6% | 3.7% | 29.5% | 3.3 ± 0.2 |
| branched | | | | | | | |
| maltodextrins | | | | | | | |

The increase in the level of branched maltodextrins according to the invention in snacks allows a significant decrease in the fat content after cooking, which does not allow, surprisingly and unexpectedly, the soluble fibre of the prior art since the fat content remains close to 35% regardless of the soluble fibre content. The measurements of INSTRON hardness show no difference on the texture of the crisps. The analyses in fact demonstrate that the soluble fibre of the prior art is more sensitive to hydrolysis than the branched maltodextrins according to the invention under the cooking conditions (frying at 195° C. for 15 seconds).

These results demonstrate that the branched maltodextrins according to the invention provide a considerable technological advantage in the preparation of snacks since they make it possible to limit the uptake of oil by the snacks, while constituting a supply of fibre. The efficacy of the said maltodextrins being ensured for a wide incorporation range, the formulators can thus adjust the contents as they wish, depending on whether they desire a product “rich in fibre” or which is a “source of fibres”.

1. Process for manufacturing low-fat fibre-enriched snacks, comprising the step consisting in incorporating into the paste used for the manufacture of said snacks from 1 to 30%, preferably from 2 to 20% and still more preferably from 2.5 to 15%, by weight relative to the finished product of branched maltodextrins having between 15 and 35% of 1→6 glucoside bonds, a reducing sugar content of less than 10%, a molecular weight Mw of between 4000 and 0.6000 g/mol and a number-average molecular weight Mn of between 2000 and 4000 g/mol.

2. Process according to claim 1, wherein said branched maltodextrins have a reducing sugar content of between 2 and 5% and an average molecular weight Mn of between 2000 and 3000 g/mol.

3. Process according to claim 1, wherein said branched maltodextrins have an insoluble fibre level greater than or equal to 50% on a dry matter basis.

4. Process according to claim 1, wherein all or some of the branched maltodextrins are hydrogenated.

5. Process according to claim 1, wherein the water content of the paste is between 20 and 45%.

6. Process according to claim 1, wherein said branched maltodextrins are mixed with 1 to 2.5% by dry weight of standard maltodextrins having a reducing sugar content greater than 5%.

7. Low-fat fibre-enriched snacks, comprising from 1 to 30%, preferably from 2 to 20% and still more preferably from 2.5 to 15%, by weight of branched maltodextrins having between 15 and 35% of 1→6 glucoside bonds, a reducing sugar content of less than 10%, a molecular weight Mw of between 4000 and 6000 g/mol and a number-average molecular weight Mn of between 2000 and 4000 g/mol.

8. Snacks according to claim 7, wherein said branched maltodextrins have a reducing sugar content of between 2 and 5% and an average molecular weight Mn of between 2000 and 3000 g/mol.

9. Snacks according to claim 7, wherein said branched maltodextrins have an insoluble fibre level greater than 50% on a dry basis.

10. Snacks according to claim 7, comprising on a dry matter basis:
6 to 14% of branched maltodextrins having a reducing sugar content of between 2 and 5%, a molecular weight Mw of between 4000 and 6000 g/mol and an average molecular weight Mn of between 2000 and 3000 g/mol;
at least 80% of a source of starch;
at least 0.5% of emulsifier.

11. Snacks according to claim 7, further comprising 1 to 2.5% by dry weight of standard maltodextrins having a reducing sugar content of greater than 5%.
